(19) United States
(12) Patent Application Publication
(10) Pub. No.: US 2005/0185849 A1
(43) Pub. Date: Aug. 25, 2005

(54) Six-Code-Element Method of Numerically Encoding Chinese Characters And Its Keyboard

(76) Inventors: YONGMIN WANG, Beijing (CN); ZHAOLU WANG, Manchester (GB)

Correspondence Address: ZHAOLU WANG, FLAT 4B, LIVINGSTONE PLACE, ANSON ROAD, MANCHESTER, M14 5ET, GB

(21) Appl. No.: 10/711,884

(22) Filed: Oct. 12, 2004

(30) Foreign Application Priority Data
Feb. 16, 2004 (CN) 2004100394832
Aug. 18, 2004 (SG) 200404678-5
Sep. 3, 2004 (GB) 0419538.4

(51) Int. Cl. G06K 9/72

(52) U.S. Cl. 382/229

(57) ABSTRACT

On the basis of vast and numerous statistical analysis and theoretical research, this invention creates a practical method of using six code elements to numerically encode Chinese characters and Chinese words and phrases and inputting codes by numeric keys. The encoding method of only selecting a character's first several and the last code elements can considerably improve the code uniqueness and input efficiency. One who can write Chinese characters is able to master this method within ten minutes. Therefore, this invention can effectively solve the worldwide Chinese people's difficulties of inputting Chinese characters onto electronic products with numeric keypads, such as mobile phone, telephone, computer etc. The description of this application includes two figures: this invention's Keyboards (FIG. 1) and the Flow Chart of Character-Searching Software bases on this invention (FIG. 2), and a comparison table in terms of efficiency among existing methods and this invention.

In 1983, this inventor created WuBiZiXing technology, a universal system of encoding Chinese characters using the standard English keyboard, and obtained American, British and Chinese patents. That invention has solved the problem of efficiently inputting Chinese characters into computers, and become the dominant and most popular technology in this realm. But with the day-by-day growing demand for handling Chinese characters in other digital devices, such as mobile phones and PDAs, an easy and efficient method using numerical keys to input Chinese characters is universally desired.

This invention aims to solve the difficulties in learning and popularizing technology of encoding Chinese characters, and make it possible to encode Chinese characters with only numerical keys.

This invention relates to a universal system for encoding Chinese characters by using six code elements, and a kind of Chinese keyboard designed on the basis of the system. It can be realized entirely by using the six numeric keys on a numeric keypad of mobile phone, telephone or computer etc, to encode and input Chinese characters and Chinese words and phrases. The present invention is characterized in decomposing Chinese characters into six code elements: [symbol] which are respectively represented by six numbers “1 2 3 4 5 6” and in correspondence with the six numeric keys on a keyboard.

According to this invention, Chinese characters are regarded as a spelling of the above code elements. One can encode or keyboard a character in unit of code element in the order of handwriting. The code of a character can comprise the character's whole code elements, or just include the first several and the last code elements. When a character happens to have elements less then the minimum number set in the system, the code comprises its whole code elements. For example:

The character: [symbol] It can be decomposed into [symbol] [symbol] It's code for whole elements is 6341126, and the code for the method of encoding first four and the last code elements is 63416, and the code for the method of encoding first three and the last code elements is 6346. As for the character [symbol] which is decomposed into [symbol] for all the three encoding methods above, its code is 62.

In this invention, [symbol] are named as the five basic strokes. In each kind of strokes those similar in form are put together according to their writing order. Hereby [symbol] can also represents [symbol] can also represent [symbol] can also represent [symbol] can also represent all the various turning strokes as

[symbol]

The existing technology is using 1, 2, 3, 4, 5 to represent [symbol] There are 5 strokes, and 5 numbers for encoding Chinese characters. On the basis of the existing technology, this present invention adds into a new code element [symbol] which corresponds to the numeric key 6, and becomes a new design. For example:

| Character | Codes based on | Codes based on |
|---|---|---|
| Examples | The existing technology | This invention |
| [symbol] | 2512 | 62 |
| [symbol] | 3123251 | 312346 |
| [symbol] | 2512121354251 | 621213546 |
| [symbol] | 2511121 | 66121 |
| [symbol] | 25115 | 665 |

We can see from the above table, the lengths of the codes encoding by the six code elements of this invention are shorter than that of by the existing technology. To input these characters, the existing technology needs to strike 37 times of numeric keys, while this invention only needs 25.

This invention, only using five strokes and [symbol] for encoding Chinese characters and taking whole code elements or the first four and the last one as a code, is unprecedented in the Chinese character encoding technology.

Through vast and numerous statistics and contrast researches on Chinese characters' components and their frequencies, the inventor discovered that the character-constituting frequency of [symbol] (including [symbol] is 34%, much higher than that of the other compound components (Chinese characters' geometrical elements containing two or more strokes, like [symbol] The total frequency of application of the Chinese characters which contain [symbol] (and [symbol] reaches as high as 44.35%.

Here is the statistical result of the appearance frequencies of the six code elements in 6763 Chinese characters (which constitute a character set as national standard GB2312-80):

| | Appearance Frequency | Appearance Frequency |
|---|---|---|
| Code Elements | with [symbol] | without [symbol] |
| [symbol] | 18,459 | 21,870 |
| [symbol] | 11,061 | 13,728 |
| [symbol] | 11,495 | 11,495 |
| [symbol] | 12,012 | 12,012 |
| [symbol] | 10,054 | 12,721 |
| [symbol] | 3,411 | 0 |

This is not only the reason that this invention chooses only [symbol] but not other components as the code element, but also the essential reason that this invention has a substantial advantage of practicability comparing with the existing technology. This invention cannot be deduced simply from the existing technology. Data in the comparative table below is the important basis for optimally selecting code elements and cannot be predicted by anybody without creative work.

Comparative Table of Total Frequency of Components in the Most
Commonly Used 1000 Chinese Characters

| | | Character-constituting | Application |
|---|---|---|---|
| Order | Components | Frequency % | Frequency % |
| 1 | [symbol] | 34.00 | 44.35 |
| 2 | [symbol] | 7.70 | 9.36 |
| 3 | [symbol] | 8.70 | 7.74 |
| 4 | [symbol] | 1.10 | 5.31 |
| 5 | [symbol] | 5.70 | 5.13 |
| 6 | [symbol] | 4.00 | 4.92 |
| 7 | [symbol] | 4.60 | 4.40 |
| 8 | [symbol] | 4.80 | 4.04 |
| 9 | [symbol] | 4.60 | 4.01 |
| 10 | [symbol] | 3.40 | 3.83 |
| 11 | [symbol] | 5.90 | 3.64 |
| 12 | [symbol] | 3.40 | 3.61 |
| 13 | [symbol] | 4.50 | 3.55 |
| 14 | [symbol] | 3.30 | 3.34 |
| 15 | [symbol] | 2.60 | 2.92 |
| 16 | [symbol] | 4.10 | 2.85 |
| 17 | [symbol] | 4.20 | 2.77 |
| 18 | [symbol] | 2.20 | 2.62 |
| 19 | [symbol] | 1.20 | 2.55 |
| 20 | [symbol] | 2.20 | 2.55 |
| 21 | [symbol] | 1.20 | 2.48 |
| 22 | [symbol] | 4.00 | 2.48 |

The above research result shows that, [symbol] has the highest character-constituting and application frequencies among all the compound components of Chinese character. Therefore, optimally selecting [symbol] as a new code element will effectively shorten the length of codes, reduce key-press times, and considerably increase the uniqueness of code and input efficiency. This is a creative design of this invention. The meaning of [symbol] in this invention is just as important as the nib to a pen.

In addition, according to this invention, When encoding the most commonly used Chinese characters like [symbol] (and [symbol] R) don't need to be decomposed into single strokes. As a result, not only the process of inputting the most commonly used Chinese characters is considerably simplified, but also the identical codes are greatly reduced, as shown in the table below (Identical codes are for the first six digits):

| | The existing | | | | |
|---|---|---|---|---|---|
| | technology | | This invention | | |
| Chinese | | Other Characters | Encoding | Encoding the first | Other Characters |
| characters | Codes | with identical codes | whole elements | four and the last one | with identical codes |
| [symbol] | 32511354 | [symbol] | 366354 | 36634 | None |
| | | [symbol] | | | |
| | | [symbol] | | | |
| [symbol] | 31234251 | [symbol] | 312346 | 31236 | [symbol] |
| | | [symbol] | | | [symbol] |
| | | [symbol] | | | |
| [symbol] | 2512 | [symbol] | 620 | 620 | None |
| | | [symbol] | | | |
| | | [symbol] | | | |
| [symbol] | 251112134 | [symbol] | 6612134 | 66124 | [symbol] |
| | | [symbol] | | | |
| | | [symbol] | | | |
| [symbol] | 25112141 | [symbol] | 611214 | 61124 | [symbol] |
| | | [symbol] | | | |
| | | [symbol] | | | |

It can be seen from the examples above that the existing technology has too many identical codes, while there are no or very few identical codes when using this invention to encode these characters.

When we encode 6763 characters in China's national standard character set GB2312-80, comparative table of “Code uniqueness” between this invention and the existing technology can be shown as:

| | | | Characters with no identical | |
|---|---|---|---|---|
| | | | codes + | |
| | | | Characters | |
| | | | with 2 identical codes + | |
| | Characters | | Characters | |
| | with no identical codes | | with 3 identical codes | |
| | Characters | Proportion | Characters | Proportion |
| The | 428 | 6.33% | 428 + 392 + | 16.47% |
| existing | | | 294 = 1114 | |
| technology | | | | |
| This | 730 | 10.79% | 730 + 602 + | 26.26% |
| invention | | | 444 = 1776 | |

| | | |
|---|---|---|
| Conclusion | The code uniqueness of | The code uniqueness |
| | this invention is 70% | of this invention is 59% |
| | higher than that of | higher than that of the |
| | the existing technology. | existing technology. |

It can be seen that this invention has an obvious advantage in terms of practicability because of its code uniqueness. Compared with the existing technology, this invention has made an important technical progress.

In addition, there are 96 characters which contain [symbol] and [symbol] in the 500 commonly used characters, and they hold 19% of these 500. Because these characters have the highest frequency of application, this invention improves their code uniqueness, thus definitely has more outstanding practicability than the existing technology.

Compared with the existing technology, this invention sacrifices very little in terms of easy to learn, because it has only added into one more code element and used one more key. But the substantial technical progress, which is made by this invention, is very obvious. This is the creativeness and practical value of this invention.

This invention also characterizes in that when using the six code elements [symbol] to input simplified/traditional Chinese characters in the order of handwriting, the encoding can be completed either when the character just appears on the screen, or when the character's whole code elements are inputted.

In order to abridge the codes, this invention allows to select part of a character's code elements, that is, only select the character's first several, and the last several or one code elements for encoding. For example, selecting a character's first 5 and the last 1 code elements, or selecting its first 4 and the last 1 code elements, or selecting its first 3 and the last 1 code elements, or selecting its first 4 and the last 2 code elements, or selecting its first 3 and the last 2 code elements to encode and input the Chinese character by numerical keys.

Chinese characters forms can be classified by the information of their forms into two basic topological patterns, namely, Compound and Singular. Compound topological-patterned character can be divided into at least two parts visually, like [symbol] While single topological-patterned character can't be divided, such as [symbol] According to this invention, when encoding the characters, as for the compound, one can divide it into two parts, and just encode the first and the last code elements of its first part, and then encode the first three and the last code elements of the second part, so the maximum length of a compound character's code is six. As for the single topological-patterned character, one just needs to encode its first four and the last code elements, and the maximum length of code is five.

According to this invention, the most commonly used character component [symbol] is encoded as “6”. Based on this, the component [symbol] can be regarded as two [symbol] So [symbol] can be encoded as “66”. For example, the code of [symbol] is 661; the code of [symbol] is 66124; and the code of [symbol] is 665.

In this invention, considering character component's derivation and its intuitional meanings, the component [symbol] in the character [symbol] is also encoded as 6. Thus, for example, [symbol] is encoded as 611214; [symbol] is encoded as 66; [symbol] is encoded as 6134.

In the process of the key-in of a character, in case of identical codes, all the characters are ordered by the frequency of application. A more frequently used character will first appear at the right position of the line on the screen.

This invention can be used to handle both simplified/traditional characters and words and phrases. When inputting phrases, one can switch (for example, press “*” key to signal) the system into a state of only-phrase inputting, or ignore the states to mix the single character and words and phrases to input.

There are various and flexible ways of encoding phrases, such as selecting 2-4 code elements from each character of a 2-character phrase, selecting 2-3 code elements from each character of a 3-character phrase, selecting 2 code elements from each character of a 4-or-more-character phrase, or, selecting 2-3 code elements from the first two and the last characters of a 3-or-more-character phrase. For example:

2-Character Phrase:|

[symbol] —554414 (method 1: [symbol] first 2 elements+ [symbol] first 4 elements)
[symbol] —551441 (method 2: [symbol] first 3 elements+ [symbol] first 3 elements)
   3-Character Phrase:
Simplified: [symbol] —664554 (first 2 elements for [symbol] respectively)
Traditional: [symbol] —144512 (first 2 elements for [symbol] respectively)
   Multiple-Character Phrase:
[symbol] —623261 (first 2 elements for [symbol] respectively)
[symbol] —*314413 (first 2 elements for [symbol] respectively)

Since the method of encoding phrases is choosing the first several code elements (most of them are roots of Chinese characters) of each character, so the codes in this invention have been well dispersed and can avoid identical codes between phrases and single characters. For example, selecting the first three code elements from each character of [symbol] thus its code is “441441”. Because there is no character which contains two [symbol] (a root of Chinese character), this phrase will not have identical code with single characters. This design makes it possible to input single characters and phrases together. It is a creativeness of this invention.

This invention also characterizes in its simple and easy-to-remember rules. Generally, one who can write Chinese characters is able to master this method within ten minutes.

The distribution of the numeric keys used in this invention can be in the way of a telephone keypad, namely, “1, 2, 3” are distributed on the top row of the keypad; and the numeric keys also can be distributed according to the PC numeric keyboard, namely, “1, 2, 3” are on the bottom row. And no matter adopting what kind of key distribution, the five basic strokes and [symbol] can be printed or carved on the six numeric keys 1, 2, 3, 4, 5, 6.

This invention can be used to encode and input all simplified/traditional Chinese characters in any character sets.

This invention is also a creative method of sorting and searching Chinese characters in dictionaries. The process is: encode all the Chinese characters and phrases into numbers by this invention, and then sort the Chinese characters in the increasing order of their codes, and make it be an index of Chinese characters and words and phrases in a dictionary. This is going to be a more practical, easier and quicker character-searching method than any of the existing ones.

The method of encoding Chinese characters by this invention can be brought into the primary or middle school education over the countries and areas where using Chinese characters. It can be designed into many kinds of teaching materials and software in order to let children know each character's correct writing order and know how to input them into computer, mobile phone and other digital devices.

After encoding all Chinese characters and words and phrases according to this invention, we can design the input software for computers and mobile phones, and character-searching software depending on input data. Thereafter this invention can be applied onto all kinds of communication and special products that need to input Chinese characters with numeric keypads, such as mobile phone, computer, and Chinese PDA, etc.

The great progress made by this invention can be illuminated in Table 1. This table shows the comparative results between various existing mobile-phone-Chinese-character-input methods with this invention. When we use all these methods to input 1000 most commonly used Chinese characters, it can be found that this invention needs the least average key-press times. So obviously this invention is the most efficient technology.

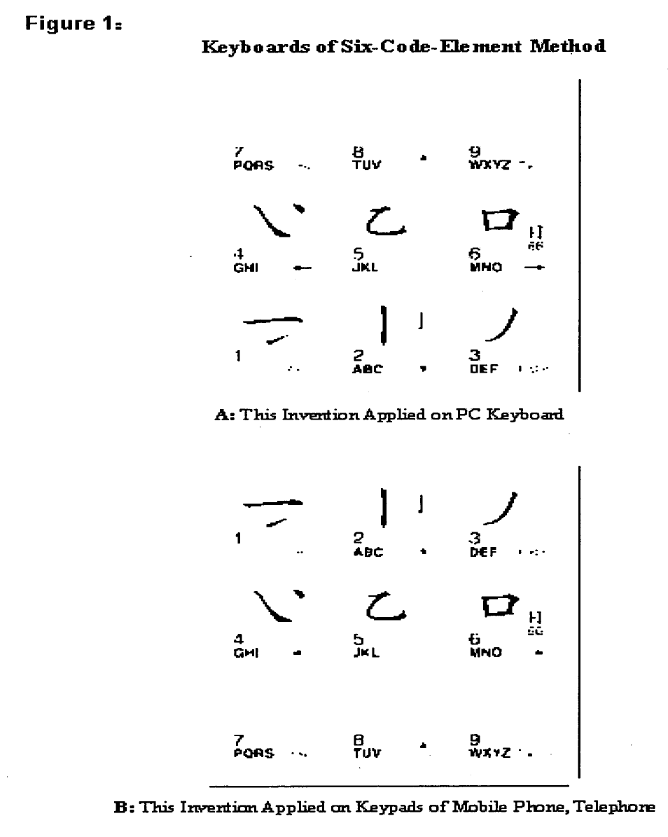

The design of this invention's keyboard is shown in FIG. 1. Case A is how the numeric keys distribute on PC keyboard, and Case B is how they distribute on mobile phone and telephone′ keypads. Different distributions do not affect on the substantive characteristics of this invention.

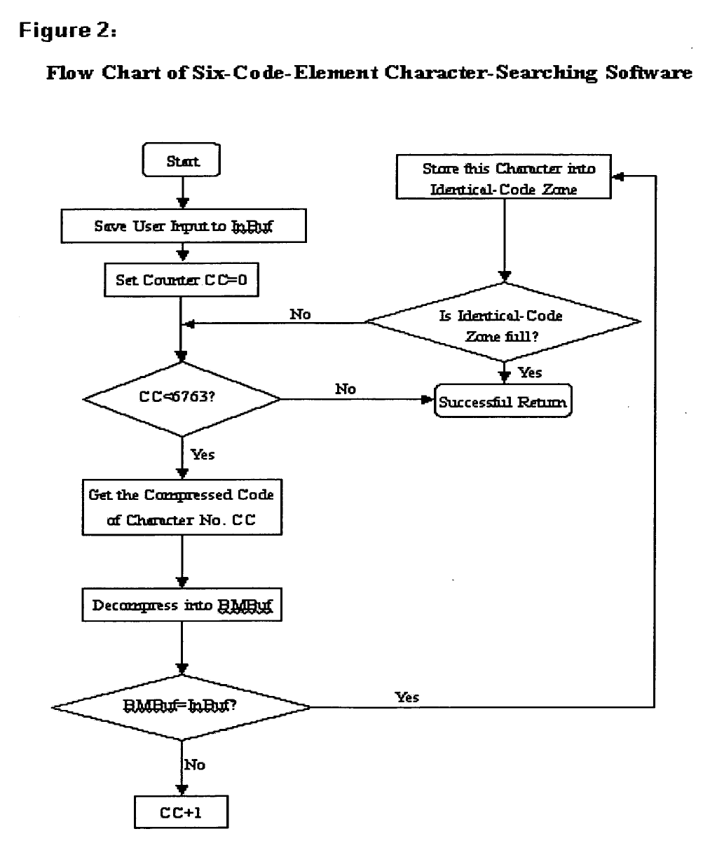

When this invention is realized on PC, the brief flow chart of the Chinese-character-searching software is shown in FIG. 2.

TABLE 1
Comparison of Key-Press Times Among Various Methods
(Encoding 1000 Most Commonly Used Chinese Characters)

(Times of Pressing Keys)

| | | | | Existing Mobile-Phone-Chinese-Character | | | | |
|---|---|---|---|---|---|---|---|---|
| | | This Invention | | Input Method | | | | |
| | | Whole | First four | Nokia | Motorola | Konglia | Hai'er | Samsung |
| | | Elements | & Last one | (5 keys) | (iT&P) | (9 keys) | (8 keys) | (I9) |
| | | Average | Average | Average | Average | Average | Average | Average |
| No. | CHARAC. | 4.6 | 4.3 | 6.7 | 6.1 | 6.6 | 6.3 | 5.1 |
| 1 | [symbol] | 1 | 1 | 2 | 2 | 8 | 5 | 1 |
| 56 | [symbol] | 5 | 5 | 6 | 6 | 6 | 4 | 5 |
| T0 | [symbol] | 5 | 5 | 6 | 5 | 8 | 6 | 5 |
| 105 | [symbol] | 4 | 4 | 6 | 6 | 8 | 6 | 4 |
| 140 | [symbol] | 6 | 6 | T | 6 | 6 | 6 | 6 |
| 1T6 | [symbol] | 4 | 4 | 6 | 6 | 8 | 6 | 4 |
| 210 | [symbol] | 4 | 4 | 6 | 6 | 6 | 6 | 4 |
| 246 | [symbol] | 4 | 4 | 6 | 4 | 6 | 6 | 4 |
| 280 | [symbol] | 4 | 4 | T | T | T | T | 6 |
| 516 | [symbol] | 6 | 6 | 6 | 6 | 6 | 6 | 6 |
| 560 | [symbol] | 4 | 4 | 6 | 6 | 8 | 6 | 4 |
| 586 | [symbol] | 6 | 6 | 6 | 6 | 6 | 6 | 6 |
| 420 | [symbol] | 4 | 4 | 6 | 4 | 6 | 6 | 4 |
| 466 | [symbol] | 6 | 6 | T | 6 | T | T | 4 |
| 490 | [symbol] | 6 | 6 | 8 | T | 8 | T | 6 |
| 626 | [symbol] | 6 | 6 | 6 | T | 8 | 6 | 6 |
| 6 [symbol] 0 | [symbol] | 6 | 6 | 8 | 8 | T | 8 | 6 |
| 696 | [symbol] | 6 | 4 | 8 | 6 | 8 | 8 | 6 |
| 650 | [symbol] | 6 | 4 | T | T | T | T | 6 |
| 666 | [symbol] | 4 | 4 | T | T | 6 | 6 | 6 |
| T00 | [symbol] | 4 | 4 | T | T | 8 | 6 | 6 |
| 756 | [symbol] | 6 | 6 | 9 | 8 | 10 | 8 | T |
| TT0 | [symbol] | 6 | 6 | T | 6 | 6 | T | 6 |
| 805 | [symbol] | 6 | 6 | 9 | 8 | 9 | 9 | T |
| 840 | [symbol] | 5 | 5 | 11 | 8 | 11 | 11 | 4 |
| 8T5 | [symbol] | 4 | 4 | 8 | T | 9 | T | T |
| 910 | [symbol] | 6 | 6 | 9 | 10 | 8 | 9 | 8 |
| 946 | [symbol] | T | 6 | 11 | 11 | 9 | 11 | 9 |
| 980 | [symbol] | 6 | 6 | T | 6 | T | T | 6 |
| 1000 | [symbol] | 6 | 6 | T | T | T | T | 6 |

1. A universal system of encoding Chinese characters characterized in placing six optimally selected code elements: [symbol] respectively onto six numeric keys “1,2,3,4,5,6” on the numeric keypad of PC, Mobile phone, telephone or other digital devices, and encoding Chinese characters by decomposing them into the mentioned code elements on the keypad in the order of handwriting, and then selecting each character's first several and the last code elements, or selecting all its code elements as the character's code for the purpose of input. If a character happens to have elements less then the minimum number set in the system, the code comprises its whole code elements.

2. A method as claimed in claim 1, in which one can also encode each character by selecting its first several and last several code elements as its numerical code, such as: the first three and the last two, or the first four and the last three, or the first five and the last two, etc.

3. A method as claimed in claim 1, in which [symbol] is regarded as two [symbol] and thus it is represented by “66” in the process of encoding and inputting.

4. A method as claimed in claim 1, in which considering character component's derivation and its intuitional meanings, the component [symbol] in the character [symbol] is also encoded as 6.

5. A method as claimed in claim 1, in which Chinese characters can be classified into two basic topological patterns: Compound and Singular. The encoding method for compound characters is flexible, one can select various number of code elements of each part of a compound character as its code. For example: selecting the first and the last code elements of the compound character's first part, and then add the first three and the last code elements of its second part for encoding.

6. A method as claimed in claim 1, which can be also used to encode Chinese words and phrases. The encoding method for words and phrase is to select 2 to 4 code elements of each Chinese character. Words and phrases can be inputted together with single characters, or inputted separately by shifting to a system state for only inputting words and phrases.

7. A method as claimed in claim 1, in which the distribution of the numeric keys can be in the way of a telephone keypad, namely, “1, 2, 3” are distributed on the top row of the keypad; and the numeric keys also can be distributed according to the PC numeric keyboard, namely, “1, 2, 3” are on the bottom row. Changing the corresponding places between “1,2,3,4,5,6” and [symbol] does not affect the substantial characteristics of this invention.

8. A method and keyboard as claimed in claim 1, in which one can also add into other Chinese character components or use more other numeric keys. For example, add component [symbol] on the numeric key 1, use numeric key “7” to represent “+”.

9. A method as claimed in claim 1, which can be used to encode and input both simplified and traditional Chinese characters in various character sets.

10. A method as claimed in claim 1, which can be also used as a way of sorting and searching Chinese characters and words and phrases. For example, one can make the numeric codes encoded by this method into an index of Chinese dictionary for searching characters.

11. According to any one of proceeding claims 1-10, the present invention of encoding Chinese characters and words and phrases can be used in any large, medium, small and mini sized computers, mobile phones, Chinese PDAs, as well as the systems for Chinese information processing and communication.
